(19) United States
(12) Patent Application Publication
(10) Pub. No.: US 2009/0265581 A1
(43) Pub. Date: Oct. 22, 2009

(54) Data system having a variable clock pulse rate

(76) Inventors: Yorck von Collani, Beilstein (DE); Thomas Kottke, Ehningen (DE)

Correspondence Address: KENYON & KENYON LLP, ONE BROADWAY, NEW YORK, NY, 10004, US

(21) Appl. No.: 11/666,410

(22) PCT Filed: Oct. 25, 2005
(86) PCT No.: PCT/EP05/55549

§ 371 Date: Jun. 5, 2009

(30) Foreign Application Priority Data
Oct. 25, 2004 (DE) 10 2004 051 950.1
Oct. 25, 2004 (DE) 10 2004 051 992.7
Sep. 23, 2005 (DE) 10 2005 045 399.6

(51) Int. Cl. G06F 11/30; G06F 1/04; G06F 11/28

(52) U.S. Cl. 714/34; 713/500; 714/47; 714/E11.178; 714/E11.179

(57) ABSTRACT

A data processing system includes an execution unit operating in a clocked manner, a clock pulse generator for delivering a clock signal for the execution unit, and a monitoring unit for monitoring the regular operation of the execution unit. The clock pulse generator is configured for delivering the clock signal having a controllable frequency. The monitoring unit is functionally connected to the clock pulse generator in order to reduce the frequency of the clock signal when irregular operation of the execution unit is detected.

### FIELD OF THE INVENTION

The present invention relates to a data processing system having an execution unit, such as a microprocessor, operating in a clocked manner, a clock pulse generator for delivering a clock signal for the execution unit, and a monitoring unit for monitoring the proper operation of the execution unit.

### BACKGROUND INFORMATION

Such monitoring units, which are also known as “watchdogs,” are typically used for detecting an undefined state or crash of the execution unit and, if necessary, for resetting the execution unit in order to restore a defined operating state. While accepting a temporary interruption of the operation of the execution unit during the reset, such a “watchdog” is in the position to correct a fault condition which may result from a spontaneous processing error due to information loss, for example, caused by the effect of cosmic or other ionizing radiation, or the like. Circuitry or software-related structural defects of the data processing system which result in reproducible errors in processing cannot be intercepted by such a “watchdog,” which cannot prevent the conditions that result in the error from occurring in a predictable manner.

Another possible reason for processing errors in an electronic data processing system is transit-time effects. Since the electrical signals may only propagate at a certain speed on a semiconductor chip or between multiple chips, the length of the signal paths must be shorter and coordinated more accurately the higher the clock frequency is at which the system is operated. Parasitic capacitances on the signal lines may delay changes in the signal levels. Since these parasitic capacitances may stray because of the manufacturing process, it is common in the production of a processor to test for the maximum clock frequency at which the processor operates reliably. The processor is released for this frequency (minus a safety margin) and it is assumed that the processor may be reliably operated at this approved maximum frequency and at clock frequencies below it.

It has already been proposed to operate processors for network-independent applications at different clock frequencies depending on the utilization factor. The goal of this measure is to minimize the power consumption of the processor. Since this power consumption increases linearly with the clock frequency, it is desirable to operate the processor at a clock pulse rate which is not higher than is necessary for handling the current tasks of the processor.

It can be observed that ageing phenomena of electronic components result in an increase in the likelihood of spontaneous processing errors in a data processing system. This increase may be explained, for example, by long-term changes on the boundary surfaces of the semiconductor substrate, on which the circuits are implemented, and which result in changes in the parasitic capacitances which strain the circuits. A migration of dopant material in circuit elements cannot be ruled out at high operating temperatures, the effects of such a migration being the greater, the smaller the structures, formed on the semiconductor substrates, are. In view of the trend toward ever higher integration densities, an increasing importance of reliability problems caused by ageing is to be reckoned with.

### SUMMARY OF THE INVENTION

A data processing system is created by the present invention which, despite the above-described problems, ensures a high degree of operational reliability in the long-term and which is thus particularly well suited for safety-critical applications in which it is important to avoid spontaneous function failures as much as possible.

In a data processing system which has an execution unit operating in a clocked manner, a clock pulse generator for delivering a clock signal for the execution unit, and a monitoring unit for monitoring the proper operation of the execution unit, these advantages are achieved by the fact that the clock pulse generator is configured for delivering the clock signal with a controllable frequency and that the monitoring unit is functionally connected to the clock pulse generator in order to reduce the frequency of the clock signal when an irregular operation of the execution unit is detected.

It is assumed that the above-described parasitic capacitances or the decrease in the efficiency of circuit components, potentially caused by dopant migration, are responsible for a significant portion of spontaneous errors occurring in the data processing system. By reducing the clock pulse rate when such errors occur, only part of the computing capacity, which the system could achieve under optimum conditions, is compromised; the general reliability of the system, however, remains intact.

In order to keep a useful application, which at least temporarily fully utilizes the computing performance of the system achievable using an originally specified high clock pulse rate, executable in the event of a reduction of the clock pulse rate, the useful application should advantageously be subdivided into a plurality of functions, the execution of at least one of the functions, which is considered dispensable in an extreme case, being enabled or disabled as a function of the current clock pulse rate of the system.

The monitoring unit may include a watchdog unit known per se, which detects irregular operation of the execution unit when a function signal fails to appear from the execution unit in a predefined time period, which, however, does not reset the data processing system in a conventional manner in the event of the absence, but rather only causes the frequency of the clock signal to be reduced.

Alternatively or in combination, the monitoring unit may be configured to cause a test processing run by the processing unit to be executed at a current clock pulse rate and at a clock pulse rate to be modified with respect to the current clock pulse rate and to detect irregular operation of the execution unit when the result of the test processing run carried out at the current clock pulse rate and the result of the test processing run carried out at the modified clock pulse rate are different.

The modified clock pulse rate is preferably an increased clock pulse rate with respect to the current clock pulse rate. This makes it possible to detect a tendency of the data processing system to produce spontaneous errors even before the limiting clock frequency, above which processing errors occur, has dropped to the level of the current clock frequency.

The monitoring unit which controls the execution of the test processing run may be simply and cost-effectively implemented in the execution unit by way of software.

According to another embodiment, the monitoring unit includes a second execution unit and means for comparing the processing results of the two execution units, and it is configured to detect irregular operation when the results do not match. A one-time execution of the test processing run is sufficient here for assessing the reliability of the data processing system.

For testing the operational reliability, it is also appropriate in this embodiment to increase the clock frequency temporarily above a current clock frequency and to lower the clock frequency below said current clock frequency when irregular operation at the increased clock frequency is detected.

The data processing system should have means for issuing a warning signal when the clock frequency drops below a lower limit.

In particular, the data processing system may be a control unit for a motor vehicle, an engine control unit in particular.

An object of the present invention is also a method for operating an execution unit, operating in clocked operation, of a data processing system, in particular a data processing system of the above-described type in which the execution unit is tested for proper operation at a high clock frequency and the clock pulse rate is lowered when irregular operation of the execution unit is detected, the test being repeated at regular intervals. The regular test may be carried out in particular when the data processing system is switched on and/or turned off or periodically during operation of the data processing system.

Further features and advantages of the present invention arise from the following description of exemplary embodiments with reference to the appended figures.

### BRIEF DESCRIPTION OF THE DRAWING

FIG. 1 shows a block diagram of a data processing system according to a first embodiment of the present invention.

FIG. 2 shows a flow chart of an operating method executed by the data processing system in FIG. 1.

FIG. 3 shows a block diagram of a second embodiment of a data processing system according to the present invention.

### DETAILED DESCRIPTION

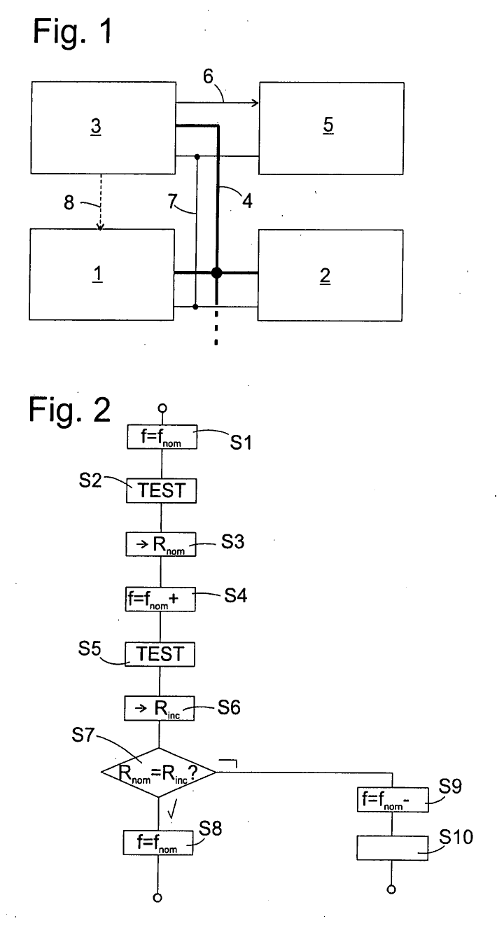

The data processing system schematically shown in FIG. 1 includes a microprocessor 1, a main memory 2, and a monitoring unit 3 which communicate with each other and possibly with peripherals (not shown) via a data and address bus 4; the peripherals may be different depending on the application of the system and, for example in the event of an application as an engine control unit, may include diverse sensors for detecting operating parameters of the engine and actuators for influencing these and other parameters of the engine. Furthermore, the system includes a clock pulse generator 5 which delivers a clock signal having a frequency which is specified by monitoring unit 3, via a control line 6, to microprocessor 1, main memory 2, and monitoring unit 3 via a clock line 7.

Main memory 2 contains program instructions of a useful application to be executed by microprocessor 1 and of a test processing run.

Microprocessor 1 is specified for a working clock frequency by the manufacturer. Under normal operating conditions, monitoring unit 3 actuates clock pulse generator 5 in order to generate this specified clock frequency, while microprocessor 1 executes the useful application. Whenever the system is switched on, in the case of a system operating as an engine control unit by turning the ignition key, for example, microprocessor 1 executes an initialization procedure prior to the start of the useful application, which is explained on the basis of FIG. 2. In a first step S1, monitoring unit 3 sets clock frequency f of the clock pulse generator to frequency fₙₒₘ specified for microprocessor 1. At this clock frequency, microprocessor 1 executes the above-mentioned test processing run in step S2. This test processing run, for example, may be made up of a sequence of arithmetic or logical operations which are executed on constants read from main memory 2 and should thus produce the same end result in each execution. The last step S3 of the test processing run is writing the result to an address which is assigned to monitoring unit 3 so that the monitoring unit receives and buffers result Rₙₒₘ.

Monitoring unit 3 subsequently increases clock frequency f to fₙₒₘ+Δ (S4) and causes microprocessor 1 to repeat the test processing run at this increased clock frequency (S5). In this way, result R_{inc} is again written into monitoring unit 3 (S6). The monitoring unit compares in step S7 the two received results Rₙₒₘ and R_{inc}. In the event of a match it is assumed that processor 1 operated correctly at both clock frequencies fₙₒₘ and fₙₒₘ+Δ. In this case, clock frequency f is reset in step S8 to fₙₒₘ and microprocessor 1 starts to execute the useful application.

If a non-match of the results is detected in step S7, it means that increased clock frequency fₙₒₘ+Δ is not reliable. In order to maintain a safety margin from this non-reliable frequency, a new, reduced operating frequency f=fₙₒₘ−Δ is set in step S9. Based on a list prepared by the system's manufacturer and stored in main memory 2, microprocessor 1 checks in step S10 whether the useful application contains functions whose execution must be blocked at the reduced clock pulse rate in order to maintain the functionality of the essential features of the useful application and to prevent inadmissibly long response times of the useful application to outside events and, if needed, to block these functions. Furthermore, a warning signal is issued to a user in step S10 when at least one of the following conditions is met:

a) a repeated reduction of the clock frequency by A would require the blocking of at least one function of the useful application;

b) the reduction of the clock pulse rate in step S9 resulted in the blocking of one function;

c) all functions non-vital for the useful application are already blocked so that further reduction in the clock pulse rate could not be absorbed by blocking additional functions, but would result in the inoperability of the entire system.

Steps S1 through S3 and steps S4 through S10 do not have to be executed consecutively. It is conceivable, for example, to execute steps S1 through S3 only once during a first start-up of the system and to keep its result Rₙₒₘ stored in monitoring unit 3 so that later reliability tests of the system may be limited to the execution of steps S4 through S10.

This is appropriate in particular when reliability tests are executed periodically with the system running since, for the execution of steps S4 through S10, the useful application must only be interrupted for half as long as for the execution of the entire method shown in FIG. 2.

In order not to delay the start of the useful application by the reliability test according to FIG. 2, it is possible to execute this test not at each start-up of the system, but rather directly prior to its shut-off; of course, in this case exactly as in the previous case, an operating frequency f, possibly newly established in step S9, is used as specified frequency fₙₒₘ in a subsequent repetition of the method.

In addition to the above-described task of comparing results Rₙₒₘ and R_{inc} of the two test processing runs, monitoring unit 3 may also perform, in a manner known per se, the task of detecting an undefined operating state or crash of microprocessor 1. For this purpose, the useful application is configured in such a way that it causes a dead man's signal to be generated in regular time intervals which is received by monitoring unit 3. This dead man's signal may be, for example, a read access to the above-mentioned address to which microprocessor 1 writes the results of the test processing runs. In monitoring unit 3, this dead man's signal resets a timer whose latency time is longer than the intended time interval between two dead man's signals. As long as the dead man's signals arrive in the intended time intervals, the timer is regularly reset and cannot expire. If, as a result of a processor crash, the dead man's signal fails to appear and the timer expires, then monitoring unit 3 triggers a reset of microprocessor 1 via a reset line 8 (FIG. 1), thereby causing it to restart the useful application.

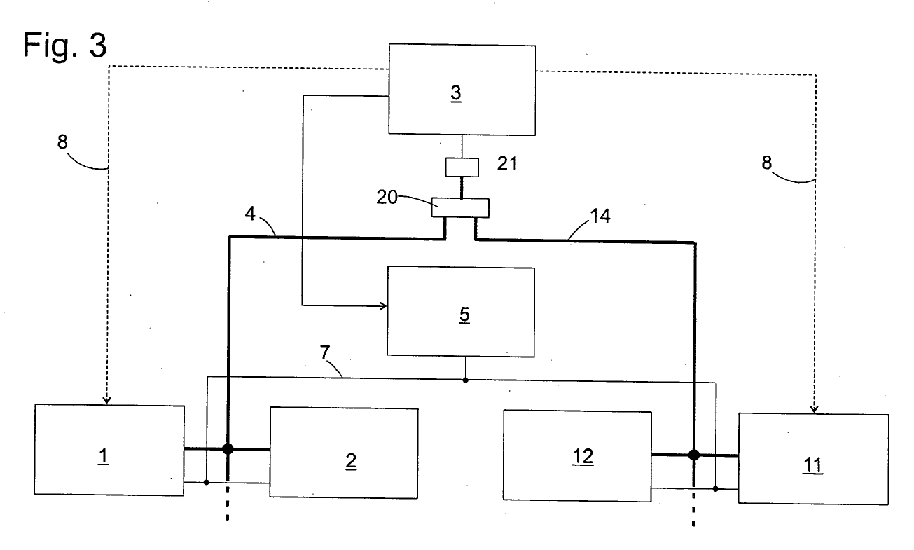

FIG. 3 shows a second embodiment of a data processing system according to the present invention having two microprocessors 1, 11 which each communicate with an assigned main memory 2, 12 and possibly with peripherals (not shown) via a data/address bus 4, 14. A data processing system having such a structure is suitable in particular in an engine control unit for an engine having six or more cylinders in which the cylinders are divided into two groups which are each controlled by one of the two processors 1, 11. Processors 1, 11 receive a clock signal from a shared clock pulse generator 5 via a clock line 7. The frequency of the clock signal is controlled by a monitoring unit 3 which is also assigned to both processors 1, 11. All strands of buses 4, 14, data lines as well as address lines, are connected to a bank of XOR gates 20 whose output assumes the value “true” exactly when the values on the two homologous strands of buses 4, 14, which are connected to the two inputs of the same gate 20, differ. The outputs of XOR gates 20 are each connected to an input of an OR gate 21 whose output thus always assumes the value “true” when the values on two arbitrary homologous strands of buses 4, 14 differ.

Reset lines 8, which perform the same function as in the embodiment of FIG. 1, may be provided between monitoring unit 3 and processors 1, 11.

Possible functions of this embodiment are described in the following with reference to FIG. 2.

According to a first alternative, monitoring unit 3 starts the operating reliability test, as in step S4, by increasing the frequency of clock signal f beyond a frequency fₙₒₘ currently used in normal operation and then causes a test processing run (S5) to be executed by microprocessors 1, 11 whose results are not needed by the useful application, but are only used for the reliability test. During this processing, logic gates 20, 21 continuously compare the data and addresses generated by microprocessors 1, 11 according to step S7 in FIG. 2. If these data and addresses are the same during the entire test processing run, both processors 1, 11 operate reliably and the clock frequency is reset to fₙₒₘ in step S8. However, if a deviation occurs in one data value or one address, the method branches to step S9 where the clock frequency is reduced and it is established in step S10, as explained above, whether and possibly which functions of the application program have to be blocked and a warning is possibly issued to the user.

Since not only final results of the test processing run are compared according to this embodiment, but also all interim results including the addressed locations, an error is detected using the same number of program steps of the test processing run with a higher degree of probability than in the first embodiment.

The data processing system in FIG. 3 offers the additional possibility of detecting errors of processors 1, 11 even when they simultaneously execute identical instructions at the normal clock frequency fₙₒₘ, e.g., in a starting phase of the useful application in which identical initializations are carried out for both processors 1, 11. This allows for a test of the operating reliability without any expenditure of time.

Processors and monitoring units are described in the above examples as separate units. Of course, processors having an error detection function which is integrated and hardwired into the processor circuit for detecting ECC or parity errors in the data read by the processor may also be used; such a processor may be understood as a combination of processor and monitoring unit in terms of the preceding description.

1-13. (canceled)

14. A data processing system, comprising:
an execution unit operating in a clocked manner;
a clock pulse generator for delivering a clock signal for the execution unit; and
a monitoring unit for monitoring the proper operation of the execution unit, wherein the clock pulse generator is configured for delivering the clock signal having a controllable frequency and that the monitoring unit is functionally connected to the clock pulse generator in order to reduce the frequency of the clock signal when an irregular operation of the execution unit is detected.

15. The data processing system as recited in claim 14, wherein the monitoring unit includes a watchdog unit which detects irregular operation of the execution unit when a function signal from the execution unit fails to appear in a predefined time period.

16. The data processing system as recited in claim 14, wherein the monitoring unit is configured to cause a test processing run to be executed by the processing unit at a current clock pulse rate and at a clock pulse rate modified with respect to the current clock pulse rate and to detect irregular operation of the execution unit when the result of the test processing run carried out at the current clock pulse rate and the result of the test processing run carried out at the modified clock pulse rate are different.

17. The data processing system as recited in claim 16, wherein the modified clock pulse rate is an increased clock pulse rate with respect to the current clock pulse rate.

18. The data processing system as recited in claim 17, wherein the monitoring unit is implemented in the execution unit in the form of software.

19. The data processing system as recited in claim 14, wherein the monitoring unit includes a second execution unit and an arrangement for comparing the processing results of the two execution units, and is configured for detecting irregular operation when the results do not match.

20. The data processing system as recited in claim 19, wherein the clock pulse generator is configured to temporarily increase the clock pulse rate above a current clock pulse rate and to lower the clock pulse rate below the current clock pulse rate when irregular operation at the increased clock pulse rate is detected.

21. The data processing system as recited in claim 14, further comprising an arrangement for issuing a warning signal when the clock pulse rate is reduced below a lower limit.

22. The data processing system as recited in claim 14, wherein the execution unit is also configured for executing a useful application which includes a plurality of functions, the execution of at least one of the functions being enabled or disabled as a function of the current clock pulse rate.

23. The data processing system as recited in claim 14, wherein the data processing system is a motor vehicle control unit.

24. A method for operating an execution unit which operates in a clocked manner, comprising:
testing the execution unit for regular operation at a high clock pulse rate; and
reducing the clock pulse rate when irregular operation of the execution unit is detected, wherein the test is repeated in a regular manner.

25. The method as recited in claim 24, wherein the test is carried out when the data processing system is switched on and/or turned off.

26. The method as recited in claim 24, wherein the test is carried out periodically during operation of the data processing system.
